(19) United States
(12) Patent Application Publication
(10) Pub. No.: US 2011/0243207 A1
(43) Pub. Date: Oct. 6, 2011

(54) System and Method for Adapting Codebooks

(75) Inventors: Yang Tang, San Diego, CA (US); Pengfei Xia, San Diego, CA (US)

(73) Assignee: FutureWei Technologies, Inc., Plano, TX (US)

(21) Appl. No.: 13/011,679

(22) Filed: Jan. 21, 2011

Related U.S. Application Data
(60) Provisional application No. 61/320,976, filed on Apr. 5, 2010.
(60) Provisional application No. 61/320,979, filed on Apr. 5, 2010.

(51) Int. Cl. H04B 17/00; H04L 27/00

(52) U.S. Cl. 375/224; 375/295

(57) ABSTRACT

A system and method for adapting codebooks are provided. A method for communications device operations includes receiving a pilot signal, computing a channel estimate for a channel between a controller and a communications device, the computing being based on the pilot signal, adapting a codebook based on the channel estimate and positions of codewords in the codebook, computing a representation of the channel using the adapted codebook, transmitting the representation of the channel as feedback information, and receiving a transmission beamformed based on the feedback information.

This application claims the benefit of U.S. Provisional Applications No. 61/320,976, filed Apr. 5, 2010, entitled “Method and Apparatus of Codebook Design Extension and New PUCCH Format”, and No. 61/320,979, filed Apr. 5, 2010, entitled “Method and Apparatus of Adaptive Codebook with Un-unified Codewords Transformation” which applications are hereby incorporated herein by reference.

### TECHNICAL FIELD

The present invention relates generally to wireless communications, and more particularly to a system and method for adapting codebooks.

### BACKGROUND

Generally, in a wireless communications system, the communications system's capacity may be significantly improved when a transmitter (such as a base station (BS), NodeB, enhanced NodeB (eNB), and so on, in a downlink (DL) channel) has full or partial knowledge of a channel over which it will be transmitting. Information related to the channel may be referred to as channel state information (CSI). CSI may be obtained by the transmitter over a reverse feedback channel. A receiver (such as a mobile station (MS), User Equipment (UE), mobile, user, and so forth, in a DL channel) of transmissions made by the transmitter may transmit CSI back to the transmitter over the reverse feedback channel. The receiver may estimate the channel, generate the CSI, and feed the CSI back to the transmitter.

However, since CSI feedback consumes communications system bandwidth, there is a desire to minimize the amount of information being fedback to the transmitter. Reducing the amount of information being fedback may involve the use of techniques such as compression, quantization using codebooks, partial information feedback, and so forth.

Channel information may be in the form of instantaneous channel feedback information, such as, codebook based limited rate feedback, or statistical channel information, such as, channel mean, channel correlation matrix, and so forth. Channel information is typically fedback from the receiver to the transmitter.

Transmit precoding/beamforming with limited feedback has been studied extensively and demonstrates significant performance gain in single user multiple input, multiple output (SU-MIMO). In general, a precoding codebook needs to be designed and maintained at both transmitter and receiver to facilitate the operation of limited feedback transmit precoding. The precoding codebook may be a collection of candidate precoding matrices and vectors and may serve as a common dictionary of current channel conditions to the transmitter and receiver.

It has been realized that codebooks should be designed to match the underlying channel characteristics. For example, for SU-MIMO independent identically distributed (iid) Rayleigh fading channels, Grassmannian line/subspace packing (GLP) based codebook has been shown to achieve near optimal performance. On the other hand, those GLP codebooks perform not so well under spatially correlated fading channels, wherein other codebooks have been shown to be relatively more robust, e.g., discrete Fourier transform (DFT) based codebooks and Householder based codebooks, among others. Other examples of codebooks may be complex Hadamard transform (CHT) based codebooks.

### SUMMARY OF THE INVENTION

These and other problems are generally solved or circumvented, and technical advantages are generally achieved, by example embodiments of the present invention which provide a system and method for adapting codebooks.

In accordance with an example embodiment of the present invention, a method for communications device operations is provided. The method includes: receiving a pilot signal; computing a channel estimate for a channel between a controller and a communications device, the computing being based on the pilot signal; adapting a codebook based on the channel estimate and positions of codewords in the codebook; computing a representation of the channel using the adapted codebook; transmitting the representation of the channel as feedback information; and receiving a transmission beamformed based on the feedback information.

In accordance with another example embodiment of the present invention, a method for controller operations is provided. The method includes: receiving feedback information from a communications device, adapting a codebook based on the feedback information and positions of codewords in the codebook; reconstructing channel information using the feedback information and the adapted codebook; adjusting a transmitter based on the reconstructed channel information; and transmitting information to the communications device using the adjusted transmitter. The feedback information includes quantized channel information.

In accordance with another example embodiment of the present invention, a communications device is provided. The communications device includes: a receiver; a channel estimate unit coupled to the receiver; an adaptation unit coupled to the channel estimate unit; a channel representation unit coupled to the adaptation unit; and a transmitter coupled to the channel estimate unit and to the channel representation unit. The receiver receives a pilot signal; the channel estimate unit computes a channel estimate based on the pilot signal for a channel between a controller and the communications device; the adaptation unit adapts a codebook based on the channel estimate and positions of codewords in the codebook; the channel representation unit computes a representation of the channel; and the transmitter transmits the representation of the channel.

In accordance with another example embodiment of the present invention, a controller is provided. The controller includes: a receiver; an adaptation unit coupled to the receiver; a reconstruction unit coupled to the receiver and to the adaptation unit; an adjusting unit coupled to the reconstruction unit; and a transmitter coupled to the adjusting unit. The receiver receives feedback information; the adaptation unit adapts a codebook based on the feedback information and positions of codewords in the codebook; the reconstruction unit reconstructs channel information using the feedback information and the adapted codebook; the adjusting unit adjusts a transmitter based on the reconstructed channel information; and the transmitter transmits information to a communications device.

One advantage presented herein is that portions of a codebook may be adapted by different transforms (or even not transformed at all) to meet channel and/or operating conditions.

A further advantage of exemplary embodiments is that a size of a codebook may be readily increased to improve quantization accuracy.

Yet another advantage of exemplary embodiments is that a codebook may be divided into different parts and each part may be transformed independently of one another.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example diagram of a portion of a communications system;

FIG. 2a illustrates an example diagram of a BS according to example embodiments described herein;

FIG. 2b illustrates an example diagram of a MS according to example embodiments described herein;

FIG. 3 illustrates an example flow diagram of MS operations in feeding back channel information to a BS according to example embodiments described herein;

FIG. 4a illustrates an example flow diagram of operations involved in adapting a codebook according to example embodiments described herein;

FIG. 4b illustrates an example flow diagram of operations involved in extending a codebook according to example embodiments described herein;

FIG. 4c illustrates an example flow diagram of operations involved in extending a codebook according to example embodiments described herein;

FIG. 4d illustrates an example flow diagram of operations involved in extending a codebook according to example embodiments described herein;

FIG. 5 illustrates an example diagram of a structure of a PUCCH packet according to example embodiments described herein; and

FIG. 6 illustrates an example flow diagram of BS operations in transmitting information to a MS according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a Third Generation Partnership Project (3GPP) Long Term Evolution (LTE) compliant wireless communications system. The invention may also be applied, however, to other wireless communications systems, such as those compliant to technical standards such as, LTE-Advanced (LTE-A), WiMAX, and so forth, that make use of feedback information to improve communications system performance. The embodiments may be applied to both single user multiple input, multiple output (SU-MIMO) and multiuser multiple input, multiple output (MU-MIMO) communications systems.

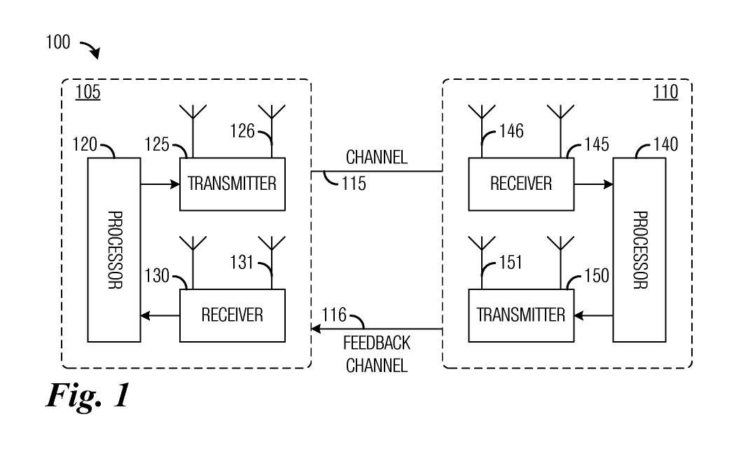

FIG. 1 illustrates a portion of a communications system 100. Communications system 100 includes a base station (BS) 105 and a mobile station (MS) 110. BS 105 communicates with MS 110 over channel 115, and MS 110 feeds back information, including channel information, to BS 105 over feedback channel 116. Channel 115 may include a downlink (DL) channel (from BS 105 to MS 110) and an uplink (UL) channel (from MS 110 to BS 105), while feedback channel 116 may be used exclusively for MS 110 to transmit information back to BS 105.

BS 105 includes a processor 120, a transmitter 125 with at least one transmit antenna 126, and a receiver 130 with at least one receive antenna 131. Similarly, MS 110 includes a processor 140, a receiver 145 with at least one receive antenna 146, and a transmitter 150 with at least one transmit antenna 151.

Receiver 145 of MS 110 receives transmissions made by transmitter 125 of BS 105 and from the received transmissions, processor 140 may compute channel information, such as channel mean, channel correlation matrix, and so forth. The channel information (in full or partial form) may be transmitted back to BS 105, where it is received by receiver 130 and provided to processor 120 that makes use of the channel information to design future transmissions.

The channel information fedback to BS 105 by MS 110 may be in the form of time domain channel information or frequency domain channel information or a combination thereof. Time domain channel information may be in the form of short term channel information or long term channel information, while frequency domain channel information may be in the form of subband channel information or wideband channel information. In general, long term channel information and/or wideband channel information may be collectively referred to as channel statistics. Short term channel information may include channel mean, and so on.

Examples of long term channel information include long term channel statistics, a function of the long term channel statistics, a time domain channel correlation matrix, eigenvectors of the time domain channel correlation matrix, eigenvalues of the time domain channel correlation matrix, angle of arrival and/or angle of departure of the channel, and so forth. Examples of wideband channel information include wideband channel characteristics, a function of the wideband channel statistics, a wideband channel correlation matrix, eigenvectors of the wideband channel correlation matrix, eigenvalues of the wideband channel correlation matrix, angle of arrival and/or angle of departure of the channel, and so on.

The discussion provided below focuses mainly on time domain channel information, i.e., short term channel information and/or long term channel information. However, the embodiments presented herein may be operable with either time domain channel information or frequency domain channel information. Therefore, the discussion of time domain channel information should not be construed as being limiting to either the scope or the spirit of the embodiments.

Short term channel information may be useful in designing transmissions at BS 105 due to rapidly changing channel conditions due to factors such as rapid mobility, channel fading, and so forth. Long term channel information may also be useful in designing transmissions, but may be more useful in adapting codebooks, transforming channels, and so on. Although both are useful on their own for designing transmissions, adapting codebooks, transforming channels, and so forth, it may be possible to combine short term channel information and long term channel information at different proportions/frequencies to further enhance communications system performance. For example, since long term channel information may remain substantially constant over short periods of time, long term channel information may not need to be fedback to BS 105 at a high frequency. However, long term channel information may provide a more accurate picture of actual channel behavior over time and may be more useful in adapting and transforming the transmission design since they tend to be immune to transient changes in the channel.

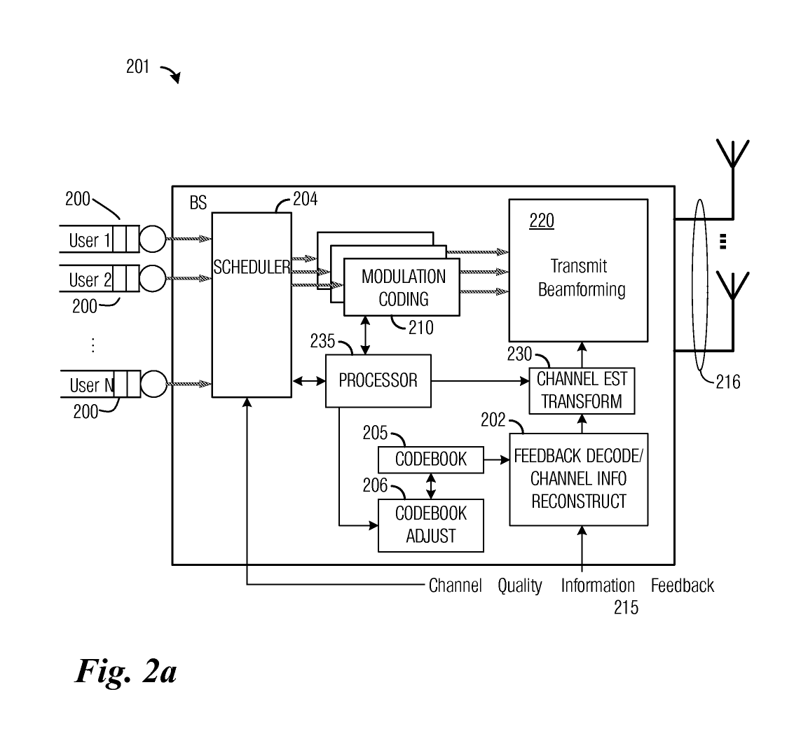

FIG. 2a illustrates a BS 201. Data 200, in the form of bits, symbols, or packets for example, destined for a plurality of MSs being served are sent to a scheduler 204, which decides which MSs will be transmitted to in a given time/frequency opportunity. For example, with MU-MIMO, scheduler 204 may select L out of K MSs for transmission at a given time, where K and L are integer values and L is less than or equal to K. The selection of the L MSs may be based on factors such as maximizing throughput, service history, MS priority, information priority, and so forth. While for SU-MIMO, scheduler 204 may select single MSs for transmission at a given time.

Data for MSs are processed by modulation and coding block 210 to convert to transmitted symbols and add redundancy for the purpose of assisting with error correction or error detection. The modulation and coding scheme is chosen based in part on information about the channel quality information feedback 215.

The output of modulation and coding block 210 is passed to a transmit beamforming block 220, which maps the modulated and coded stream for each MS onto a beamforming vector. The beamformed outputs are coupled to antennas 216 through RF circuitry. The transmit beamforming vectors may be determined by transmit beamforming block 220, which may determine the transmit beamforming vectors based on channel quality information feedback 215 as well as information from scheduler 204, which may include information regarding the MSs selected for transmission, and so on.

Feedback decode/channel information reconstruct unit 202 decodes feedback information from channel quality information feedback 215. Decoding feedback information may involve the use of a codebook 205 if channel quality information feedback 215 was quantized using a codebook by a MS. Codebook 205 may be a baseline codebook as specified by a technical standard, provided by an operator of a communications system that includes BS 201, or so forth. Alternatively, codebook 205 may be an adapted codebook that is originally a baseline codebook or another codebook that has been adapted using long term channel information (in full or partial form) or a function of long term channel information provided by the MS.

Furthermore, codebook 205 may be a resized version of the baseline codebook or another codebook that has had different portions transformed by different transforms. For example, a first third of codebook 205 may be a transformed version of a third of the baseline codebook (or another codebook) transformed with a first transform, a second third of codebook 205 may be a third of the baseline codebook (or another codebook) transformed with a second transform, and a third third of codebook 205 may be a third of the baseline codebook (or another codebook) transformed with a third transform. In other words, a transform used to adapt the baseline codebook may be both a function of the channel information as well as the codewords of the baseline codebook. A same third of the baseline codebook may be used for each third of codebook 205, or a different third of the baseline codebook may be used for each third of codebook 205, or so on. Codebook 205 may also be a part of the baseline codebook or another codebook. In other words, codebook 205 may comprise codewords that are selected from a larger codebook.

Adaptation of codebook 205 may be performed by codebook adjust unit 206. Codebook adjust unit 206 may adapt codebook 205 using feedback information provided in channel quality information feedback 215. Codebook adjust unit 206 may also make use of transforms stored in a memory to transform the baseline codebook. Codebook 205 may be implemented as a memory capable of storing a number of different codebooks, such as different baseline codebooks for different channel models, different codebooks for different MSs, different adapted codebooks for different MSs, and so forth.

In addition to including a baseline codebook and an adapted codebook, codebook 205 may also include additional codebooks that may be used to quantize channel information. For example, codebook 205 may include a codebook used to quantize channel statistics (either time domain channel statistics and/or frequency domain channel statistics), a transformed channel estimate, wherein a channel estimate is transformed based on a subspace of the channel, such as a long term channel eigenspace, a wideband channel eigenspace, and so forth.

A detailed description of preferred embodiments of adaptations of codebook 205, the baseline codebook, and so forth, are provided below.

Additionally, channel quality information feedback 215 may be encoded to protect from transmission errors. If so protected, feedback decode/channel information reconstruct unit 202 may remove the encoding used to protect channel quality information feedback 215 to produce feedback information.

Output of feedback decode/channel information reconstruct unit 202 (e.g., channel state information, channel statistics, channel correlation matrices, and so forth) may be provided to channel estimate transform unit 230. Channel estimate transform unit 230 may be used to transform an estimate of the channel to comply with a transformed channel model used at the MS. For example, channel estimate transform unit 230 may transform the channel estimate into a subspace of the channel, e.g., a long term channel eigenspace or a wideband channel eigenspace, representation of the channel estimate. Additional details on the transformed channel model are provided below. Channel quality information feedback 215 may also be provided to scheduler 204, which may use the information in its scheduling of MSs.

Scheduler 204 may use any of the known scheduling disciplines in the literature including round robin, maximum sum rate, proportional fair, minimum remaining processing time, or maximum weighted sum rate; generally scheduling decisions are based on channel quality information feedback 215 received from the plurality of MSs. Scheduler 204 may decide to send information to a single MS via transmit beamforming (SU-MIMO) or may decide to serve multiple MSs simultaneously through MU-MIMO communications.

Modulation and coding block 210 may perform any number of coding and modulation techniques including quadrature amplitude modulation, phase shift keying, frequency shift keying, differential phase modulation, convolutional coding, turbo coding, bit interleaved convolutional coding, low density parity check coding, fountain coding, or block coding. The choice of modulation and coding rate in a preferred embodiment may be made based on channel quality information feedback 215 in a preferred embodiment and may be determined jointly in scheduler 204.

While not explicitly illustrated, it is obvious to those of ordinary skill in the art that OFDM modulation can be used. Further, any number of multiple access techniques could be used including orthogonal frequency division multiple access, code division multiple access, frequency division multiple access, or time division multiple access. The multiple access technique may be combined with the modulation and coding block 210 or the transmit beamforming block 220 among others.

Channel quality information feedback 215 may, for purposes of illustration, be in the form of quantized channel measurements, modulation, coding, and/or spatial formatting decisions, received signal strength, and signal-to-interference-plus-noise measurements. A processor 235 may be used to execute applications for BS 201, and may be used to control the operation of units such as codebook adjust unit 206, channel estimate transform unit 230, modulation and coding block 210, scheduler 204, and so forth.

FIG. 2b illustrates MS 203. MS 203 may have one or more receive antennas 251, connecting through RF circuitry to a receiver signal processing block 250. Some of the key components of receiver signal processing block 250 include channel estimation block 255, eigen decomposition block 260, and a mobility estimate block 265.

Channel estimation block 255 may employ any number of algorithms known in the art including least squares, maximum likelihood, maximum a postiori, Bayes estimator, adaptive estimator, a blind estimator, or so forth, to estimate a channel between MS 203 and its serving BS. Some algorithms exploit known information inserted into the transmit signal in the form of training signals, training pilots, while others use structure in the transmitted signal such as cyclostationarity to estimate coefficients of the channel between the BS and the MS.

Eigen decomposition block 260 may be used to compute eigen components of a channel correlation matrix of a channel between MS 203 and its serving BS. According to an example embodiment, eigen decomposition block 260 may make use of eigen decomposition to compute the eigen components from the channel correlation matrix provided by channel estimation block 255, which may then be fedback to the BS serving MS 203. According to an example embodiment, a subset of the total number of eigenvalues are fedback to the BS. For example, if the channel correlation matrix decomposes into four eigen components, then two largest eigen components may be fedback. It may be also possible to further reduce the amount of information fedback to the BS by quantizing the eigenvalues using quantization block 275 using codebook 280.

Codebook 280 may be a baseline codebook as specified by a technical standard, provided by an operator of a communications system that includes MS 203, or so forth. Alternatively, codebook 280 may be an adapted codebook that is originally a baseline codebook that has been adapted using long term channel information (in full or partial form) or a function of long term channel information measured by MS 203. Adaptation of codebook 280 may be performed by codebook adjust unit 282. Codebook adjust unit 282 may adapt codebook 280 using channel information, such as long term channel information measured by MS 203. Codebook 280 may be implemented as a memory capable of storing a number of different codebooks, such as different baseline codebooks for different channel models, different adapted codebooks adapted from different baseline codebooks, and so forth.

Codebook adjust unit 282 may adapt the baseline codebook or some other codebook using a variety of transforms. A transform may be applied to an entirety of a codebook or a portion of a codebook. Furthermore, codebook adjust unit 282 may also increase the size of a codebook (increase the number of codewords in a codebook) to increase quantization accuracy, for example. Codebook adjust unit 282 may also be used to generate a new codebook from an existing codebook by selecting certain codewords from the existing codebook.

A channel estimate transform block 270 may be used to transform a model of the channel between the BS and MS 203. For example, channel estimate transform unit 230 may transform the channel estimate into a subspace of the channel, e.g., a long term channel eigenspace or a wideband channel eigenspace, representation of the channel estimate. The transformation of the model of the channel between the BS and MS 203 may allow for a reduction in the amount of channel feedback information by feeding back a different form of channel feedback information that may be amenable to quantization using codebooks as well as reduced dimensionality, which leads to reduced codebook size, thereby increasing codebook resolution while maintaining constant codebook size or reducing codebook size while maintaining codebook resolution. Transforming the model of the channel with quantization may be shown to be equivalent to codebook quantization of an untransformed model of the channel. A detailed discussion of the transformation of the model of the channel is provided below.

As discussed above, channel state information produced from information provided by channel estimation block 255 may be quantized using a quantization block 275. Quantization block 275 quantizes the channel state information using codebook 280. An index from codebook 280 may be output from quantization block 275. An estimate of the amount of channel variation, produced by mobility estimate block 265, may be used to improve the quantization algorithm by initializing the algorithm from a previous quantization level or adjusting the amount of localization.

Feedback block 285 generates a new feedback message by combining the codebook indices output from quantization block 275. Generate channel quality information block 290 generates a special feedback control message employing the outputs of feedback block 285 to produce channel quality information feedback 215. Generate channel quality information block 290 may also apply an error correcting code to protect information in the feedback message from errors.

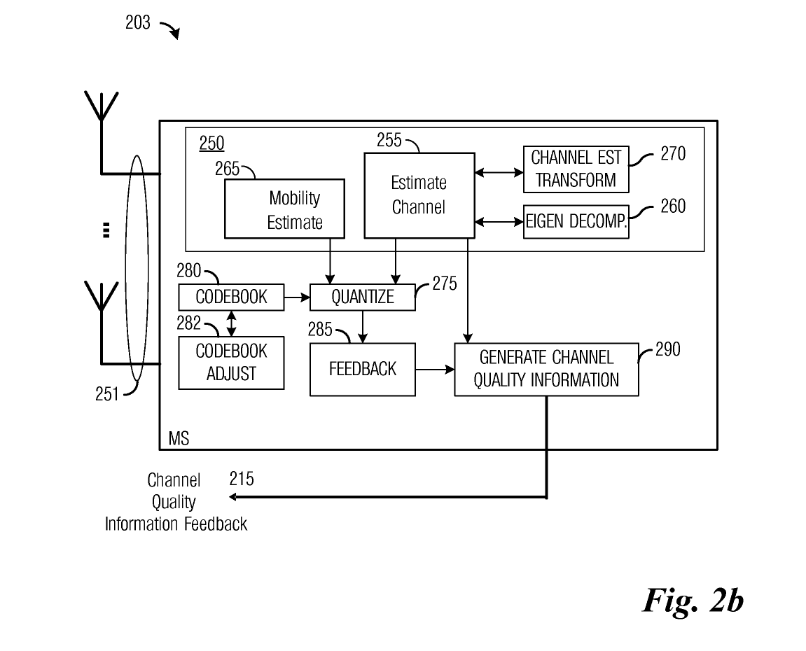

The above described embodiments of a BS 201 and MS 203 may also be illustrated in terms of methods comprising functional steps and/or non-functional acts. The following (and subsequent) description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the following description of the flow diagrams(s) for FIGS. 3, 4a, 4b, 4c, 4d, and 6—is used to indicate the desired specific use (or non-use) of such terms.

FIG. 3 illustrates a flow diagram of MS operations 300 in feeding back channel information to a BS. MS operations 300 may be indicative of operations occurring in a MS, such as MS 203, as the MS provides channel information to a BS, such as BS 201, serving the MS. MS operations 300 may occur while the MS is in a normal operating mode and while the BS continues to serve the MS.

MS operations 300 may begin with the MS receiving a pilot transmitted by the BS (block 305). The pilot may be a signal transmitted by the BS that may be used to assist the MS to join a communications network containing the BS, measure channels, and so forth. Using the pilot, the MS may measure a channel between itself and the BS and from the measurement of the channel, the MS may determine an estimate of the channel (block 310). According to an example embodiment, instead of the pilot, the MS may use a reference signal transmitted by the BS or other transmissions made by the BS to measure and determine an estimate of the channel.

The MS may adapt a codebook that it will be using to quantize the estimate of the channel (block 315). The adaptation of the codebook may make use channel information determined and maintained by the MS or provided by the BS. The adaptation of the codebook may be based on frequency domain information, time domain information, or a combination thereof. The information used in the adaptation of the codebook may be short term channel information, long term channel information, or a combination thereof.

In general, the adaptive codebook may be denoted as W_{ac}={w1_{ac}, . . . , wN_{ac}} and consists of N codewords. The adaptive codebook may be obtained by

W_{ac}=R^{a}W (1)

where W={w1, . . . , wN} is a predefined codebook consisting of N codewords, R represents the transmit channel covariance and a is a non-negative constant. More specifically, the n-th codeword of W_{ac}, denoted by wn_{ac} can be obtained by

wn_{ac}=R^{a}wn, (2)

where wn is the n-th codeword of W. It is noted that a constant factor a is used to adjust the weight of the dominant eigenvectors of R in the process of codeword transformation illustrated in Equation (2). Obviously, the larger a the closer the codeword wn_{ac} is in the sphere space to the dominant eigenvector(s) of R.

It has been shown that adaptive codebook constructed as Equation (1) may significantly improve the system performance by moment matching the channel realization. However, due to limited reference signal density, restricted feedback overhead requirement, non-negligible feedback channel error rate in the practical system, and so forth, the channel transmit covariance matrix R (or partial of R, e.g., the eigenvalues and/or eigenvectors of R) estimation, quantization and feedback is far from perfect. This degraded the effective improvement of adaptive codebook dramatically.

To make adaptive codebook more robust in the presence of the imperfection of R, the codewords in W, which might be better reflecting the channel characteristics than others, should not be transformed in the same way as other codewords. Therefore, the adaptive codebook with adaptive codewords transformation is proposed as

wn_{ac}=f(R)ₙwn,

where f(R), is defined as a transformation matrix of the n-th codeword. Note that f(R)ₙ is both a function of R and of n.

As an example, in the 3GPP Technical Standards, Release 8, a rank-1 codebook for four transmit antennas consists of 16 codewords, of which eight codewords, denoted by {w1, . . . , w8} are tailored for Uniform Linear Antenna Array (ULA) and another eight are specially designed for dual-polarized array and denoted by {w9, . . . , w16}. In a situation where a ULA is deployed in the serving eNB, the n-th codeword in the adaptive codebook is given as

$$w {n}_{a c} = \{ \begin{matrix}{R}^{0} w n , & n ∈ \{ 1 , … , 8 \} \\ {R}^{α} w n & n ∈ \{ 9 , … , 16 \} ,\end{matrix}$$

where a is a positive constant. Similarly, in a situation where a dual-polarized antenna array is used, the n-th codeword in the adaptive codebook is given as

$$w {n}_{a c} = \{ \begin{matrix}{R}^{α} w n , & n ∈ \{ 1 , … , 8 \} \\ {R}^{0} w n & n ∈ \{ 9 , … , 16 \} .\end{matrix}$$

Therefore, different portions of a codebook may be adapted differently. As shown previously, a portion of a codebook that is not to be adapted may be adapted using identity transformations, while a portion of a codebook that is to be adapted may be adapted using non-identity transformations. Furthermore, a portion of a codebook may be “zeroed” out by transforming with a zero transform, e.g., a zero matrix. As an example, a codebook may be partitioned into two portions and each portion may be adapted by a different transformation. Alternatively, each codeword of a codebook may be adapted by a different transformation.

Alternatively, specified codewords of a codebook may be adapted by a single transform. For example, codewords 1, 4, 9, and 15 may be adapted by a first transform, codewords 0, 2, and 7 may be adapted by a second transform, and the remaining codewords may be adapted by a third transform.

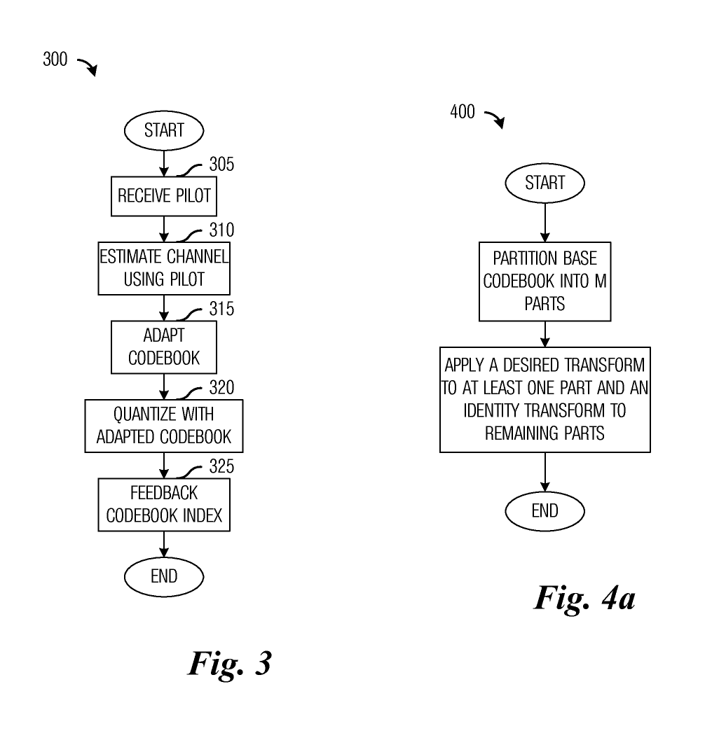

FIG. 4a illustrates a flow diagram of operations 400 involved in adapting a codebook. The codebook being adapted may be partitioned in to M parts and one or more of the M parts may be adapted with a desired transform and each of the remaining parts may be transformed with an identity transform, i.e., the R⁰ transform. According to an example embodiment, the M parts do not need to be equal.

Returning now to FIG. 3, quantization in many different scenarios may be a problem. For example, in the 3GPP Technical Standards, Release 8, a finite codebook design is needed to feedback a precoder matrix index (PMI). For example, the codebook design includes codebooks of different ranks expressible as

W₁=[W_{1,1}W_{1,2} . . . W_{1,N}_{₁}]

W₂=[W_{2,1}W_{2,2} . . . W_{2,N}_{₂}]

W₃=[W_{3,1}W_{3,2} . . . W_{3,N}_{₃}]

W₄=[W_{4,1}W_{4,2} . . . W_{4,N}_{₄}]

where W₁, W₂, W₃, W₄ are codebooks of rank 1, 2, 3, 4 respectively, and each codebook consists of N1, N2, N3, N4 codewords each of rank 1, 2, 3, and 4 respectively. In the following discussion, a focus in on the rank-1 codebook design while the general principle applies to other ranks as well.

It is often advantageous to extend the codebook size from N1 to K, for example, with K and N1 being integer values, and K>N1. Extending the codebook size could be used to increase the feedback accuracy, reduce quantization error, or otherwise improve overall performance, for example. The disclosed method in the following serves as a simple technique to extend the codebook W₁ of size N1 to a larger codebook Ω₁ of size K.

In particular, the codebook W₁ (or any selected subset of W₁) may be extended. In the following, it may be possible to replace W_{1I} by a selected subset of W₁, and extend it to a codebook (Ω₁) of size K=P*N1 as follows

Ω₁=[Φ₀W₁Φ₁W₁ . . . Φ_{P-1}W₁], (3)

where

Φ₀=diag([1111])

Φ₁=diag([1e^{j2π/32}e^{j4π/32}e^{j6π/32}])

Φ₂=diag([1e^{j4π/32}e^{j8π/32}e^{j12π/32}])

Φ₃=diag([1e^{j6π/32}e^{j12π/32}e^{j18π/32}]) (4)

are diagonal matrices, permutations of diagonal matrices, unitary matrices, and so forth. Equation (4) displays examples of Φ when P is equal to 4. Φ for other values of P may have substantially the same appearance. As discussed herein, the matrices are diagonal matrices. The matrices may also take the form of a permutation of a diagram matrix, e.g.,

$$[ \begin{matrix}0 & a & 0 & 0 \\ b & 0 & 0 & 0 \\ 0 & 0 & 0 & c \\ 0 & 0 & d & 0\end{matrix} ] . \qquad ( 5 )$$

The matrices may also be unitary matrices.

FIG. 4b illustrates a flow diagram of operations 425 involved in extending a codebook. The codebook being extended, W₁, has N1 codewords and is being extended to a new codebook, Ω₁, with P*N1 codewords. The new codebook Ω₁ may be formed by transforming the codebook W₁ with P transforms.

Returning now to FIG. 3, in a situation when the number of codewords (K) in the new codebook Ω₁ is not a multiple of N1, but K>P*N2 and K<(P+1)*N1, then part of the original codebook W₁ may be supplemented. The new codebook Ω₁ may be expressed as

Ω₁=[Φ₀W₁Φ₁W₁ . . . Φ_{P-1}W₁Φ_{P}\tilde{W}₁], (6)

where \tilde{W}₁ is a subset of W₁, containing selected columns of W₁ only. Φ for a case when P is equal to 4 is as shown in Equation (4). Φ for other values of P may have substantially the same appearance.

FIG. 4c illustrates a flow diagram of operations 450 involved in extending a codebook. The codebook being extended, W₁, has N1 codewords and is being extended to a new codebook, Ω₁, with a number of codewords that is not a multiple of N1. The new codebook Ω₁ may be formed by transforming the codebook W₁ with P transforms and one transform of \tilde{W}₁.

Returning now to FIG. 3, it is also possible to divide the original codebook into several, e.g., two, parts (e.g., W₁ₐ and W_{1b} collectively forms W₁) and apply different transformation for each part, such as

Ω₁=[Φ₀W₁ₐΦ₁W₁ₐ . . . Φ_{P-1}W₁ₐΘ₀W_{1b}Θ₀W_{1b}Θ₀W_{1b}]. (7)

FIG. 4d illustrates a flow diagram of operations 475 involved in extending a codebook. The codebook being extended, W₁, may be partitioned in to M parts and each of the M parts may be transformed with P transforms.

Equation (7) may be utilized to downsample and jointly encode multiple codebooks. For discussion purposes, consider a first codebook W₁ with 16 codewords and a second codebook W₂ also with 16 codewords. However, due to overhead restrictions, feedback channel bandwidth, and so on, reduced versions of the two codebooks are to be used in quantizing the channel estimate. Equation (7) may be used to perform the downsampling and joint encoding. Let W₁ₐ and W_{1b} be two parts of the first codebook W₁ and W₂ₐ and W_{2b} be two parts of the second codebook W₂, where it is desired to jointly encode W₁ₐ and W₂ₐ while not utilizing W_{1b} and W_{2b}. Equation (7) may be re-expressed as

Ω₁=[IW₁ₐWₛₐOW₁ₐW_{2b}OW_{1b}W₂ₐOW_{1b}W_{2b}],

where I is an identity matrix and O is a zero matrix, i.e., a zero transform.

As examples, let

W₁=[0,1,2,3,4,5,6,7,8,9,10,11,12,13,14,15]

and

W₂=[0,1,2,3,4,5,6,7,8,9,10,11,12,13,14,15].

Then W₁ₐ=[0,2,4,6,8,10,12,14] and W₂ₐ=[0,2] may be jointly encoded and a PUCCH containing indices to W₁ₐ and W₂ₐ may contain 3 bits for W₁ₐ and 1 bit for W₂ₐ. Similarly, W₁ₐ=[0,2,4,6,8,10,12,14] and W₂ₐ=[0,1] may be jointly encoded and a PUCCH containing indices to W₁ₐ and W₂ₐ may contain 3 bits for W₁ₐ and 1 bit for W₂ₐ. Alternatively, W₁ₐ=[0,2] and W₂ₐ=[0,1,2,3,8,9,10,11] may be jointly encoded and a PUCCH containing indices to W₁ₐ and W₂ₐ may contain 1 bit for W₁ₐ and 3 bits for W₂ₐ. Similarly, W₁ₐ=[0,2] and W₂ₐ=[0,1,2,3,4,5,6,7] may be jointly encoded and a PUCCH containing indices to W₁ₐ and W₂ₐ may contain 1 bit for W₁ₐ and 3 bits for W₂ₐ.

Returning now to FIG. 3, the bits to index the larger codebook (e.g., in Equation (3)) are log₂ N1+log₂ P bits. It is noted that the bits could be fedback in two different feedback instances, with one instance of feeding back log₂ N1 bits and the other instance of feeding back log₂ P bits. Generally, each feedback is recurring. It is noted that each feedback could have a different feedback period/frequency in the time/frequency domain.

The MS may then make use of the adapted codebook to quantize the channel estimate, thereby producing an index to the adapted codebook (block 320). The MS may then feedback the index to the BS (block 325).

Feeding back the index of the codeword of the adapted codebook that most closely matches the channel estimate may involve feeding back several indices, one each for the various codebooks used in quantization. As currently specified in the 3GPP Technical Standards, the feedback information is to be fed back on a Physical Uplink Control Channel (PUCCH). The PUCCH may be used to carry control channel information in the UL direction (from the MS to the BS). A PUCCH packet is specified to be 11 bits in size and includes both Channel Quality Indicator (CQI) and PMI information.

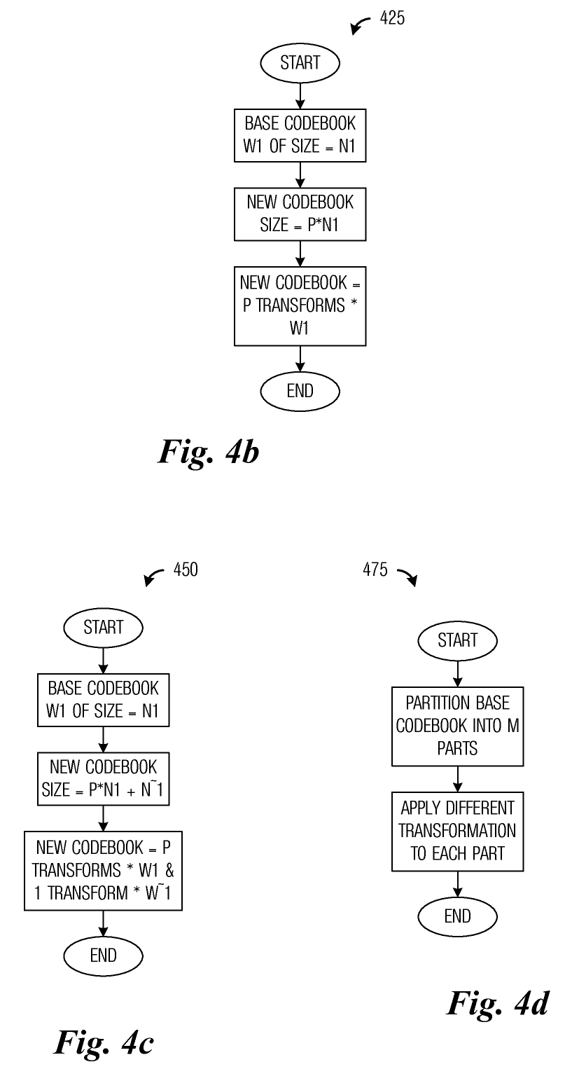

FIG. 5 illustrates a structure of a PUCCH packet 500. It may be possible to introduce a new PUCCH packet format that includes only PMI type information. As shown in FIG. 5, PUCCH packet 500 may comprise multiple segments, with each segment carrying different PMI type information. As an example, a first segment (SEGMENT 1) 505 may be used to carry X bits of PMI type information, a second segment (SEGMENT 2) 510 may be used to carry Y bits of PMI type information, and a third segment (SEGMENT 3) 515 may be used to carry Z bits of PMI type information, where X+Y+Z=11 bits.

As an example, referring back to Equation (6), if the codebook used to quantize the channel estimate is the new codebook Ω₁, then SEGMENT 1 505 may be used to feedback an index for codebook W₁, SEGMENT 2 510 may be used to feedback an index for transformation Φ, and SEGMENT 3 515 may be used to feedback subset selection information, i.e., \tilde{W}₁ information.

Returning now to FIG. 3, after feeding back the index, MS operations 300 may then terminate.

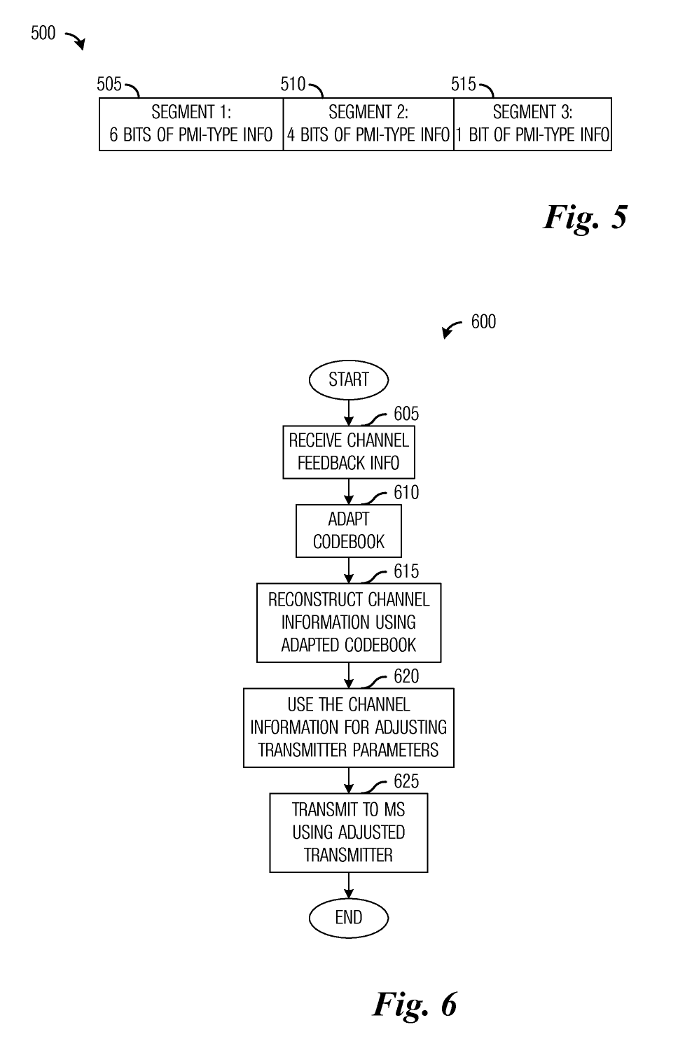

FIG. 6 illustrates a flow diagram of BS operations 600 in transmitting information to a MS. BS operations 600 may be indicative of operations occurring in a BS, such as BS 201, as the BS transmit information to a MS, such as MS 203, using channel information provided by the MS. The BS may adapt a codebook using feedback channel information the MS. BS operations 600 may occur while the BS is in a normal operating mode and is serving the MS.

BS operations 600 may begin with the BS receiving channel feedback information from the MS (block 605). According to an example embodiment, the feedback channel information includes long term channel information, such as long term channel statistics, a channel correlation matrix R, or a reduced rank representation of a channel correlation matrix Rₖ. The feedback channel information may also include short term channel information. Furthermore, the feedback channel information may be frequency domain information, time domain information, or a combination thereof. According to another example embodiment, the feedback channel information includes a function of either a channel correlation matrix R or a reduced rank representation of a channel correlation matrix Rₖ.

The BS may make use of the channel feedback information to adapt a codebook (block 610). According to an example embodiment, the BS adapts the codebook in a manner similar to an adaptation technique used at the MS to ensure that the codebook at the BS is identical to the codebook at the MS. Utilizing identical codebooks help to ensure the best performance possible. The adaptation of the codebook may make use of the channel feedback information provided by the MS and/or channel information determined and maintained by the BS.

According to an example embodiment, the adaptation of the codebook may be performed using one (or more) of the adaptation techniques described previously as codebook adaptation techniques for the MS. As discussed previously, both the MS and the BS should use the same codebook adaptation technique, which ever one is selected.

Using the adapted codebook, the BS may then reconstruct the channel information fedback by the MS (block 615). For example, the channel information may be encoded to protect from transmission errors. The BS may decode the feedback channel information to reconstruct the channel information. Additionally, if the channel information comprises an index to a codebook (or codebooks), the BS may reference the codebook(s) to reconstruct the channel information. Furthermore, the channel information comprises an index to a matching codebook for a transformed channel estimate, the BS may use information from the matching codebook corresponding to the index and perform an inverse transformation to reconstruct the channel information.

As an example, referencing back to FIG. 5, If the channel information comprises multiple indices as shown in FIG. 5, the BS may use an index contained in SEGMENT 1 505 as an index to the codebook W₁, an index in SEGMENT 2 510 as an index for transformation Φ, and information in SEGMENT 3 515 as subset selection information, i.e., \tilde{W}₁ information.

Returning now to FIG. 6, the BS may then use the feedback channel information to adjust transmitter parameters (block 620). For example, the BS may use the feedback channel information to compute a precoder for use in transmissions to the MS. The BS may use the adjusted transmitter to transmit to the MS (block 625) and BS operations 600 may then terminate.

Although the present invention and its advantages have been described in detail, it should be understood that various changes, substitutions and alterations can be made herein without departing from the spirit and scope of the invention as defined by the appended claims

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for communications device operations, the method comprising:
receiving a pilot signal;
computing a channel estimate for a channel between a controller and a communications device, the computing being based on the pilot signal;
adapting a codebook based on the channel estimate and positions of codewords in the codebook;
computing a representation of the channel using the adapted codebook;
transmitting the representation of the channel as feedback information; and
receiving a transmission beamformed based on the feedback information.

2. The method of claim 1, wherein adapting a codebook comprises applying a transform to a subset of codewords in the codebook.

3. The method of claim 2, wherein applying a transform to a subset of codewords comprises:
applying a desired transform to codewords in the subset of codewords; and
applying an identity transform to remaining codewords in the codebook.

4. The method of claim 3, wherein the identity transform comprises channel information raised to a zero power.

5. The method of claim 2, wherein the transform is based on long term channel statistics.

6. The method of claim 5, wherein the long term channel statistics are based on the channel estimate, information provided by the controller, or a combination thereof.

7. The method of claim 1, wherein adapting a codebook comprises extending the codebook to a new codebook, wherein the new codebook is larger than the codebook.

8. The method of claim 7, wherein the codebook has N1 codewords and the new codebook has P*N1 codewords, where N1 and P are integer values, and wherein extending the codebook comprises:
transforming the codebook with P transforms; and
forming the new codebook with results of each of the P transformations.

9. The method of claim 8, wherein P transforms comprise unitary matrices, diagonal matrices, permutations of diagonal matrices, unitary matrices, or combinations thereof.

10. The method of claim 7, wherein the codebook has N1 codewords and the new codebook has K codewords, where K is not a multiple of N1, K>P*N1 but K<(P+1)*N1, where K, N1, and P are integer values, and wherein extending the codebook comprises:
transforming the codebook with P transforms;
transforming a subset of the codebook with a transform; and
forming the new codebook with results of each of the P transformations and the transformation.

11. The method of claim 10, wherein P transforms and the transform comprise unitary matrices, diagonal matrices, permutations of diagonal matrices, unitary matrices, or combinations thereof.

12. The method of claim 10, wherein the subset of the codebook comprises selected columns of the codebook.

13. The method of claim 7, wherein the codebook is partitioned into M parts, where M is an integer value, and wherein extending the codebook comprises:
transforming each of the M parts of the codebook with a transform; and
forming the new codebook with results of the transformation of each of the M parts.

14. The method of claim 7, wherein the codebook is partitioned into M parts, where M is an integer value, and wherein extending the codebook comprises:
applying at least one transform to codewords in at least one part of the codebook; and
applying a zero transform to remaining parts of the codebook.

15. The method of claim 14, wherein the zero transform comprises a zero matrix.

16. A method for controller operations, the method comprising:
receiving feedback information from a communications device, wherein the feedback information comprises quantized channel information;
adapting a codebook based on the feedback information and positions of codewords in the codebook;
reconstructing channel information using the feedback information and the adapted codebook;
adjusting a transmitter based on the reconstructed channel information; and
transmitting information to the communications device using the adjusted transmitter.

17. The method of claim 16, wherein adapting a codebook comprises applying a transform to a subset of codewords in the codebook.

18. The method of claim 17, wherein applying a transform to a subset of codewords comprises:
applying a desired transform to codewords in the subset of codewords; and
applying an identity transform to remaining codewords in the codebook.

19. The method of claim 16, wherein adapting a codebook comprises extending the codebook to a new codebook, wherein the new codebook is larger than the codebook.

20. The method of claim 19, wherein the codebook has N1 codewords and the new codebook has P*N1 codewords, where N1 and P are integer values, and wherein extending the codebook comprises:
transforming the codebook with P transforms; and
forming the new codebook with results of each of the P transformations.

21. The method of claim 19, wherein the codebook has N1 codewords and the new codebook has K codewords, where K is not a multiple of N1, K>P*N1 but K<(P+1)*N1, where K, N1, and P are integer values, and wherein extending the codebook comprises:
transforming the codebook with P transforms;
transforming a subset of the codebook with a transform; and
forming the new codebook with results of each of the P transformations and the transformation.

22. The method of claim 19, wherein the codebook is partitioned into M parts, where M is an integer value, and wherein extending the codebook comprises:
transforming each of the M parts of the codebook with a transform; and
forming the new codebook with results of the transformation of each of the M parts.

23. The method of claim 19, wherein the codebook is partitioned into M parts, where M is an integer value, and wherein extending the codebook comprises:
applying a transform to codewords in at least one part of the codebook; and
applying a zero transform to remaining parts of the codebook.

24. A communications device comprising:
a receiver configured to receive a pilot signal;
a channel estimate unit coupled to the receiver, the channel estimate unit configured to compute a channel estimate based on the pilot signal for a channel between a controller and the communications device;
an adaptation unit coupled to the channel estimate unit, the adaptation unit configured to adapt a codebook based on the channel estimate and positions of codewords in the codebook;
a channel representation unit coupled to the adaptation unit, the channel representation unit configured to compute a representation of the channel; and
a transmitter coupled to the channel estimate unit and to the channel representation unit, the transmitter configured to transmit the representation of the channel.

25. The communications device of claim 24, wherein the adaptation unit is configured to adapt the codebook by applying a transform to a subset of codewords in the codebook.

26. The communications device of claim 25, wherein the adaptation adapts the codebook by applying a desired transform to codewords in the subset of codewords and applying an identity transform to remaining codewords in the codebook.

27. The communications device of claim 24, wherein the adaptation unit is configured to adapt the codebook by extending the codebook to a new codebook, wherein the new codebook is larger than the codebook.

28. The communications device of claim 27, wherein the codebook has N1 codewords and the new codebook has P*N1 codewords, where N1 and P are integer values, and wherein the adaptation unit extends the codebook by transforming the codebook with P transforms, and forming the new codebook with results of each of the P transformations.

29. The communications device of claim 27, wherein the codebook has N1 codewords and the new codebook has K codewords, where K is not a multiple of N1, K>P*N1 but K<(P+1)*N1, where K, N1, and P are integer values, and wherein the adaptation unit extends the codebook by transforming the codebook with P transforms, transforming a subset of the codebook with a transform, and forming the new codebook with results of each of the P transformations and the transformation.

30. The communications device of claim 27, wherein the codebook is partitioned into M parts, where M is an integer value, and wherein the adaptation unit extends the codebook by transforming each of the M parts of the codebook with a transform, and forming the new codebook with results of the transformation of each of the M parts.

31. The communications device of claim 27, wherein the codebook is partitioned into M parts, where M is an integer value, and wherein the adaptation unit extends the codebook by applying at least one transform to codewords in at least one part of the codebook, and applying a zero transform to remaining parts of the codebook.

32. A controller comprising:
a receiver configured to receive feedback information;
an adaptation unit coupled to the receiver, the adaptation unit configured to adapt a codebook based on the feedback information and positions of codewords in the codebook;
a reconstruction unit coupled to the receiver and to the adaptation unit, the reconstruction unit configured to reconstruct channel information using the feedback information and the adapted codebook;
an adjusting unit coupled to the reconstruction unit, the adjusting unit configured to adjust a transmitter based on the reconstructed channel information; and
a transmitter coupled to the adjusting unit, the transmitter configured to transmit information to a communications device.

33. The controller of claim 32, wherein the adaptation unit is configured to adapt the codebook by applying a transform to a subset of codewords in the codebook.

34. The controller of claim 33, wherein the adaptation adapts the codebook by applying a desired transform to codewords in the subset of codewords and applying an identity transform to remaining codewords in the codebook.

35. The controller of claim 32, wherein the adaptation unit is configured to adapt the codebook by extending the codebook to a new codebook, wherein the new codebook is larger than the codebook.

36. The controller of claim 35, wherein the codebook has N1 codewords and the new codebook has P*N1 codewords, where N1 and P are integer values, and wherein the adaptation unit extends the codebook by transforming the codebook with P transforms, and forming the new codebook with results of each of the P transformations.

37. The controller of claim 35, wherein the codebook has N1 codewords and the new codebook has K codewords, where K is not a multiple of N1, K>P*N1 but K<(P+1)*N1, where K, N1, and P are integer values, and wherein the adaptation unit extends the codebook by transforming the codebook with P transforms, transforming a subset of the codebook with a transform, and forming the new codebook with results of each of the P transformations and the transformation.

38. The controller of claim 35, wherein the codebook is partitioned into M parts, where M is an integer value, and wherein the adaptation unit extends the codebook by transforming each of the M parts of the codebook with a transform, and forming the new codebook with results of the transformation of each of the M parts.

39. The controller of claim 35, wherein the codebook is partitioned into M parts, where M is an integer value, and wherein the adaptation unit extends the codebook by applying at least one transform to codewords in at least one part of the codebook, and applying a zero transform to remaining parts of the codebook.
